(19) United States
(12) Patent Application Publication
(10) Pub. No.: US 2012/0010744 A1
(43) Pub. Date: Jan. 12, 2012

(54) METHOD AND DEVICE FOR SUPPRESSING CHATTERING OF WORK MACHINE

(75) Inventors: Toru Yamashita, Aichi (JP); Yasuhiro Komai, Aichi (JP)

(73) Assignee: NT Engineering Kabushiki Kaisha, Aichi (JP)

(21) Appl. No.: 13/259,384

(22) PCT Filed: Feb. 25, 2010
(86) PCT No.: PCT/JP2010/053491

§ 371 Date: Sep. 23, 2011

(30) Foreign Application Priority Data
Apr. 10, 2009 (JP) 2009-113056

(51) Int. Cl. G05B 19/404

(52) U.S. Cl. 700/173

(57) ABSTRACT

Disclosed herein is a chatter suppressing method for a work machine. The method comprises the steps of detecting vibration occurring when a bar tool or a workpiece is started to rotate, determining whether the vibration detected from the start of rotation has exceeded a threshold, and analyzing the vibration by Fourier series expansion when it is determined that the vibration has exceeded the threshold and adjusting the number of rotations of the spindle.

### TECHNICAL FIELD

The present invention relates to a chatter suppressing method and device for a work machine for suppressing the occurrence of chatter when machining a workpiece via a working tool.

### BACKGROUND

Generally, various machine tools are used for machining a workpiece via a working tool. For example, boring is machining a highly accurate bore at a predetermined position with an edge machining diameter of a boring bar tool by attaching a boring tool provided with the boring bar tool (edge) to a spindle of a machine tool and successively extending the boring tool along a prepared hole while rotating the boring tool at a high speed.

With this type of machine tool, a working tool and a workpiece are easily deflected by cutting resistance. This deflection causes the working tool and the workpiece to vibrate, and this vibration may appear as chatter (including so-called regenerative chatter) in machining.

In order to suppress the above-described chatter, various methods are conventionally used. For example, the invention disclosed in Japanese Published Unexamined Patent Application No. 2007-44852 includes a vibration detecting means for detecting frequencies of chatter vibration of a cutting tool, a work material, or a machining device, and a calculating means for calculating the number of rotations of the cutting tool or work material for reducing chatter vibration based on the detected frequencies of the chatter vibration.

Further, the invention includes a chatter vibration identifying means for identifying a type of chatter vibration, and a number-of-rotations changing means for changing the number of rotations of the cutting tool or the work material, and the chatter vibration identifying means identifies chatter vibration based on a change in frequency of chatter vibration when the number of rotations of the rotating means is changed by the number-of-rotations changing means.

However, in Japanese Published Unexamined Patent Application No. 2007-44852 described above, it is after chatter actually occurs that the number of rotations of the cutting tool or work material for reducing chatter vibration is calculated. Therefore, the work material is easily influenced by chatter, and may not be machined with highly accuracy.

Further, it is determined whether chatter is regenerative chatter or frictional chatter based on whether the chatter vibration frequency was changed by the change in the number of rotations of the spindle. Therefore, an operation for changing the number of rotations of the spindle is actually necessary, and the process becomes troublesome and takes much time.

The present invention was made to solve this problem, and an object thereof is to provide a chatter suppressing method and device for a work machine by which chatter can be prevented from occurring as much as possible and highly accurate machining is effectively performed with simple processes and a simple configuration.

### SUMMARY

The present invention relates to a chatter suppressing method for a work machine for suppressing the occurrence of chatter when machining a workpiece via a working tool.

This chatter suppressing method includes the steps of detecting vibration occurring when a working tool or a workpiece is started to rotate, determining whether the vibration detected from the start of rotation has exceeded a threshold, and analyzing the vibration by Fourier series expansion when it is determined that the vibration has exceeded the threshold and adjusting the number of rotations of a machine spindle based on an arithmetic expression of frequency×60/the number of cutting teeth (or multiplication thereof).

Further, the present invention relates to a chatter suppressing device for a work machine for suppressing the occurrence of chatter when machining a workpiece via a working tool.

This chatter suppressing device includes a vibration detection mechanism that detects vibration that occurs when a working tool or a workpiece is started to rotate, a determination mechanism that determines whether the vibration detected from the start of rotation has exceeded a threshold, and an arithmetic mechanism that analyzes the vibration detected from the start of rotation by Fourier series expansion when it is determined that the vibration has exceeded the threshold, and adjusts the number of rotations of a machine spindle according to an arithmetic expression of frequency×60/the number of cutting teeth (or multiplication thereof).

In the chatter suppressing method and device for a work machine according to the present invention, vibration is detected from the start of rotation and the vibration is analyzed by Fourier series expansion. In Fourier series expansion, the calculation is simple and quick processing is possible, so that immediacy is excellently improved, and before chatter actually occurs, chatter vibration can be predicted.

Therefore, regenerative chatter whose vibration grows from zero with the start of rotation can be predicted as soon as possible. Accordingly, the number of rotations of the machine spindle can be adjusted before an influence of the chatter actually occurs, and regenerative chatter can be reliably suppressed from occurring.

### BRIEF DESCRIPTION OF THE DRAWINGS

The various features, advantages and other uses of the present apparatus will become more apparent by referring to the following detailed description and drawing in which:

FIG. 1 is a schematic explanatory view of a chatter suppressing device for a work machine according to a first embodiment of the present invention.

FIG. 2 is an explanatory view of a chatter suppressing controller constituting the chatter suppressing device.

FIG. 3 is a first stage of a flowchart describing a chatter control method by the chatter suppressing device.

FIG. 4 is a second stage of the flowchart.

FIG. 5 is an explanatory view of vibration occurring when idling and vibration occurring when cutting.

FIG. 6 is a flowchart of threshold setting.

FIG. 7 is an explanatory view when the number of spindle rotations is on stability lobe.

FIG. 8 is an explanatory view at the time of stable cutting.

FIG. 9 is an explanatory view when harmonics are removed at the time of stable cutting.

FIG. 10 is an explanatory view when the number of spindle rotations is on stability lobe.

FIG. 11 is a peak explanatory view when a predictive sign of chatter appears.

FIG. 12 is a schematic explanatory view of a chatter suppressing device for a work machine according to a second embodiment of the present invention.

FIG. 13 is a schematic explanatory view of a chatter suppressing device for a work machine according to a third embodiment of the present invention.

### DETAILED DESCRIPTION

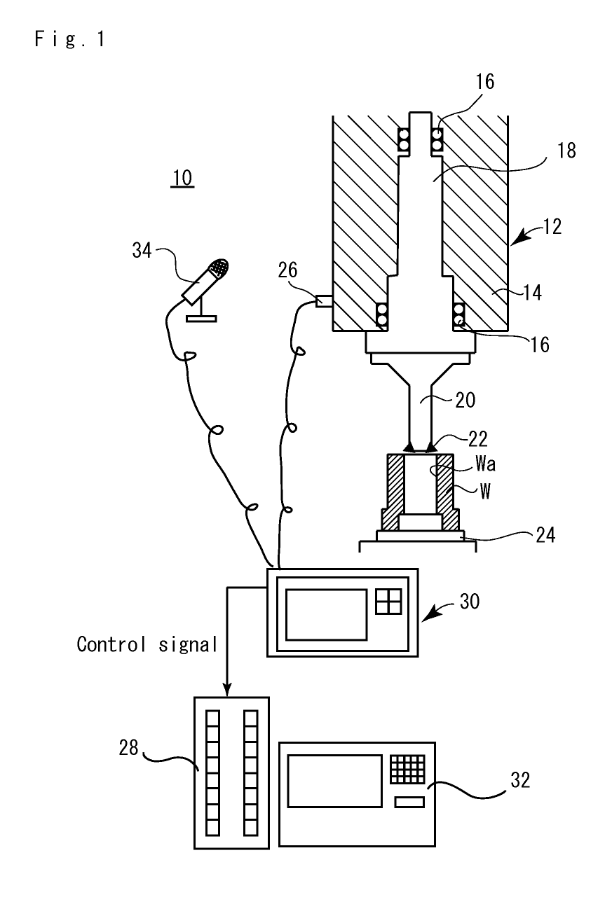

As shown in FIG. 1, the chatter suppressing device 10 for a work machine according to a first embodiment of the present invention is applied to a machine tool 12.

This machine tool 12 includes a spindle 18 provided rotatably inside a housing 14 via bearings 16 and a boring bar (working tool) 20 removably attached to the spindle 18, and a boring bar tool 22 is mounted to the tip end of the boring bar 20. On the work table 24, a workpiece W is placed.

The chatter suppressing device 10 includes an acceleration sensor (vibration detection mechanism) 26 fitted to a side portion of the housing 14 for detecting vibration occurring when the boring bar 20 is started to rotate, and a chatter suppressing controller 30 that analyzes the vibration detected from the start of rotation of the boring bar 20 by Fourier series expansion, adjusts the number of rotations of the spindle 18, and outputs an updated number to a machine control device 28. The machine control device 28 controls the machine tool 12, and is connected to a control operation panel 32.

The vibration detection mechanism uses, in addition to the acceleration sensor 26, a microphone 34 for acquiring vibration noise by acoustic waves. In addition, the acceleration sensor 26 may be attached to a workpiece W side, for example, the work table 24 instead of to the housing 14.

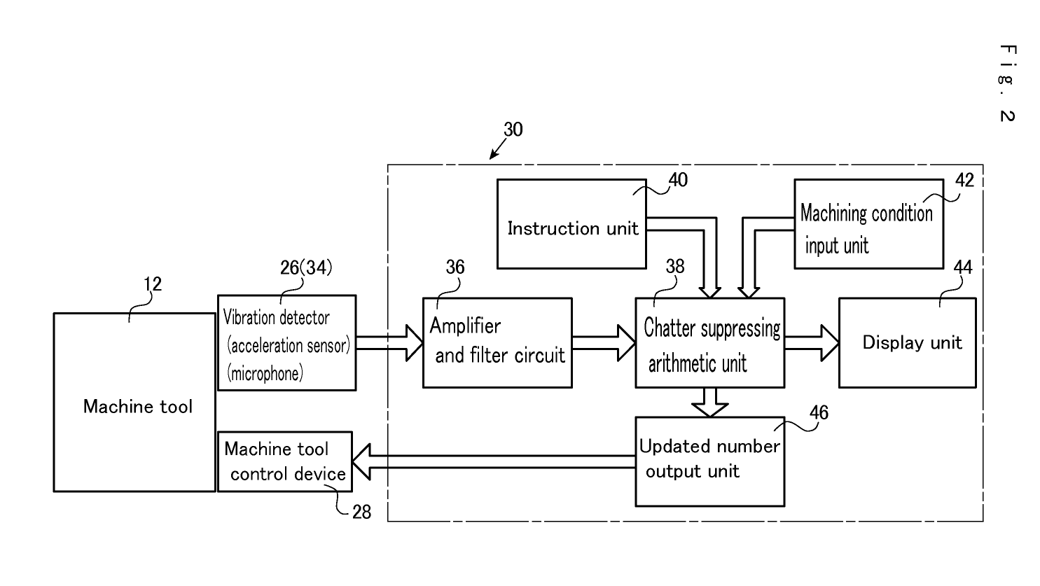

As shown in FIG. 2, the chatter suppressing controller 30 includes a chatter suppressing arithmetic unit (arithmetic mechanism) 38 that amplifies and takes-in mechanical vibration (machining vibration) detected by the acceleration sensor 26, etc., by an amplifier and filter circuit 36.

To the chatter suppressing arithmetic unit 38, an instruction unit 40 for instructing a threshold (described later) for starting arithmetic processing from a vibration monitoring state, a machining condition input unit 42 for inputting machining conditions such as the number of rotations of the spindle 18 and the number of cutting teeth of the bar tool 22, a display unit 44 for displaying the machining state, etc., to the outside, and an updated number output unit 46 for outputting the number of spindle rotations adjusted by arithmetic processing to be described later, are connected. The updated number output unit 46 automatically outputs the number of rotations of the spindle updated by the machine tool control device 28 of the machine tool 12.

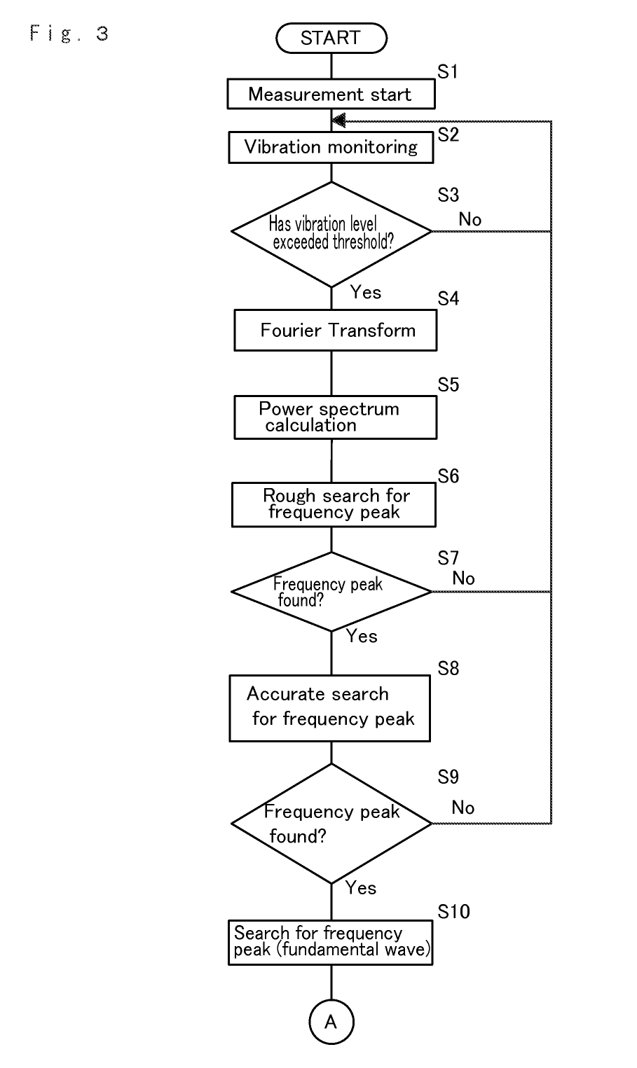

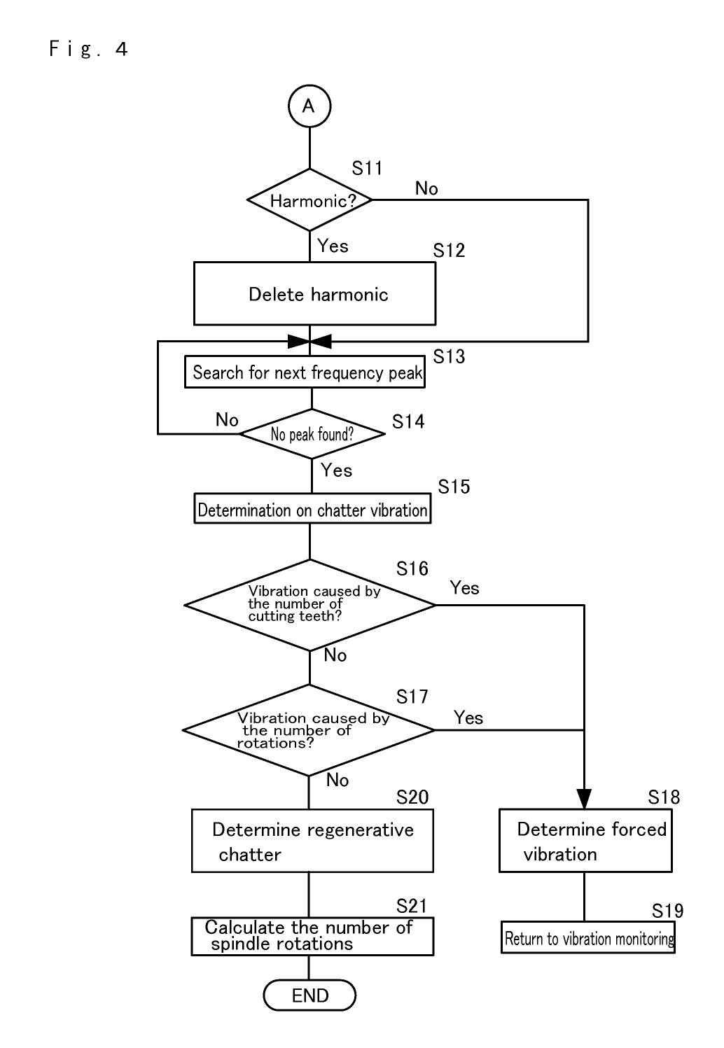

A chatter suppressing method by using the chatter suppressing device 10 configured as described above will be described hereinafter in conjunction with the flowchart shown in FIG. 3 and subsequent drawings.

As shown in FIG. 1, in the machine tool 12, the spindle 18 to which the boring bar 20 is attached is driven to rotate and extended along a prepared hole Wa of a workpiece W. Then, the boring bar 20 relatively moves to the prepared hole Wa side of the workpiece W. Therefore, the boring bar 20 rotates and the inner wall surface constituting the prepared hole Wa is bored via the bar tool 22 mounted to the boring bar 20.

The spindle 18 starts rotational driving (Step S1) and at the same time, the chatter suppressing device 10 starts monitoring of machining vibration by the acceleration sensor 26 (and/or the microphone 34) (Step S2). In the chatter suppressing arithmetic unit 38, it is determined whether machining vibration taken-in via the amplifier and filter circuit 36 has exceeded a threshold automatically set in advance, for example, vibration occurring when the spindle 18 idles (Step S3).

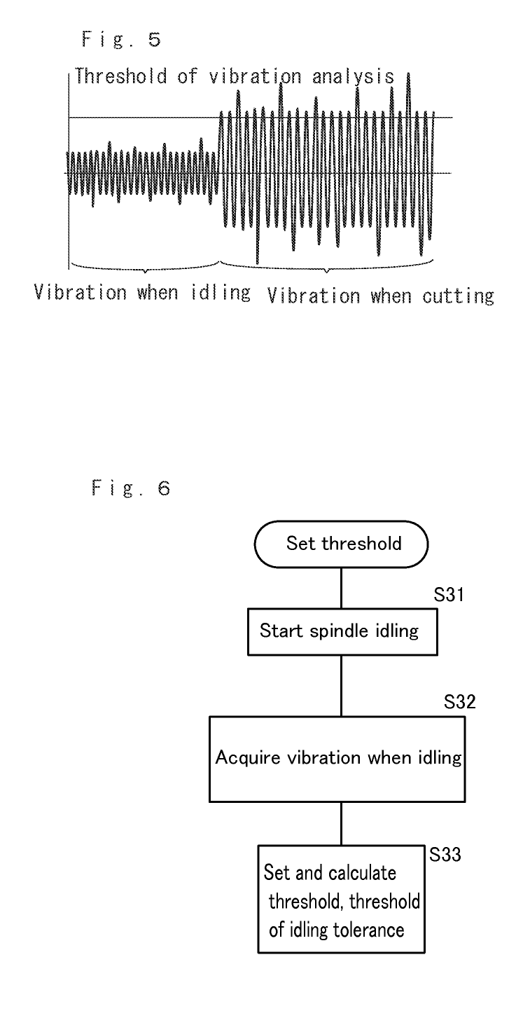

Here, vibration occurring when the spindle 18 idles before starting machining and vibration occurring when cutting change, as shown in FIG. 5, in actuality. A threshold of vibration analysis is calculated by setting the vibration occurring when the spindle 18 idles as tolerance. In detail, as shown in FIG. 6, when idling of the spindle 18 is started (Step S31), vibration in this idling is acquired (Step S32). In the machining condition input unit 42, threshold (vibration amplitude) setting calculation is performed, and a threshold of idling tolerance is set (Step S33).

Next, when it is determined that the machining vibration has exceeded the threshold (YES in Step S3), the process advances to Step S4, and arithmetic analysis of the machining vibration is performed according to Fourier transform (Fourier series expansion). In detail, time vibration f(t) is expressed as:

f(t)=Σ(aj cos 2πJt+bj sin 2πJt)

In the expression above, aj is a Fourier coefficient of cosine harmonic component of the frequency J, and bj is a Fourier coefficient of sine harmonic component of the frequency J.

The Fourier coefficients with respect to the frequency J are subjected to Fourier series expansion based on aj=½T∫f(t)cos(2πJt)dt and bj=½T∫f(t)sin(2πJt)dt. The integration interval is 0 to T, and this component interval T is an integral multiple of the period 1/J.

Here, in order to improve the real-time performance (immediacy) by Fourier series expansion, the vibration frequency at which chatter actually occurs is limited to, for example, 20 Hz to 4000 Hz to minimize the number of data to be analyzed.

Further, the process advances to Step S5, and based on the obtained Fourier coefficients, a power spectrum P(J) (maximum vibration amplitude) is calculated from P(J)=aj2+bj2.

Next, the process advances to Step S6, and a frequency peak is roughly searched. The rough search is a search for a peak value of a roughly scanned peak of the power spectrum of a vibration signal processed by Fourier series expansion. In detail, a frequency range between 20 Hz and 4000 Hz is scanned in units of 10 Hz (first frequency).

When no peak value is included (NO in Step S7), the process returns to Step S2 and vibration monitoring processing is performed. On the other hand, when it is determined that the peak value is included (YES in Step S7), the process advances to Step S8, and a peak value roughly searched for is accurately searched. Accurate search is scanning of several tens of Hz before and after the roughly searched peak value in units of 1 Hz (second frequency).

Then, the process advances to Step S9, and when no peak value is included (NO in Step S9), the process returns to Step S2 and vibration monitoring processing is performed. On the other hand, when it is determined that a peak value is included (YES in Step S9), the process advances to Step S10 and a frequency peak (fundamental wave) of maximum power is searched.

Here, when mechanical vibration is subjected to Fourier series expansion, a fundamental frequency component and harmonic components (second-order harmonic and third-order harmonic, etc.) are calculated. The harmonic components are frequencies that are integral multiples of the fundamental frequency, and are unnecessary signals having no relation to the physical cause of vibration that the fundamental frequency originally has. Therefore, in Step S11, when it is judged that a harmonic component is included (YES in Step S11), the process advances to Step S12, and this harmonic is deleted. Accordingly, only a fundamental wave related to the vibration cause is obtained.

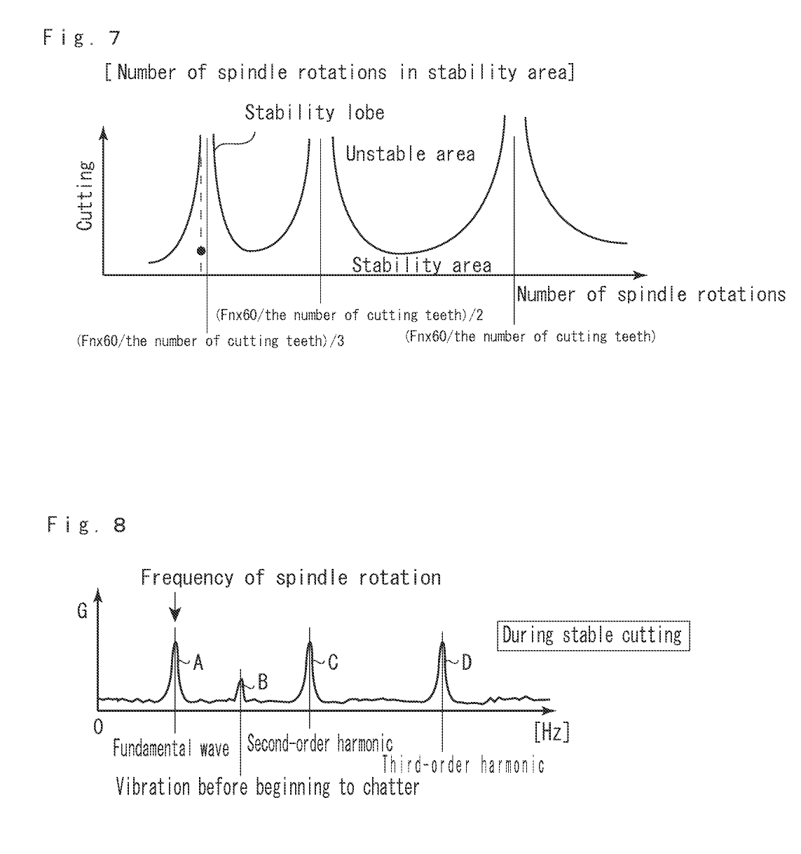

Normally, during stable machining by the machine tool 12, as shown in FIG. 7 and FIG. 8, the number of rotations of the spindle 18 is in a stability area. FIG. 7 shows a change of limit cutting at which chatter occurs with respect to the number of rotations of the spindle 18, and the stability limit becomes partially high, that is, a stability pocket exists. Specifically, by making the number of rotations of the spindle 18 equal to vibration frequency of chatter×60/the number of cutting teeth or an integer fraction thereof, chatter vibration is suppressed.

On the other hand, as shown in FIG. 8, the frequency components to be calculated include, for example, a fundamental frequency component (the number of rotations when the spindle 18 idles) A, a vibration component B before growth to chatter, and a second-order harmonic component C and a third-order harmonic component D. The fundamental frequency component A is a numeric value input in advance in the machining condition input unit 42, and it is not instructed to change the numeric value.

Therefore, as harmonic deletion processing, first, the taken vibration frequencies are subjected to Fourier series expansion and then converted into power spectrum, and from the data, a frequency with the highest power peak is selected. Next, this is defined as a fundamental wave, a frequency that is an integral multiple of the fundamental wave is regarded as harmonic, and the harmonic is compared with the calculated peak value of the power spectrum.

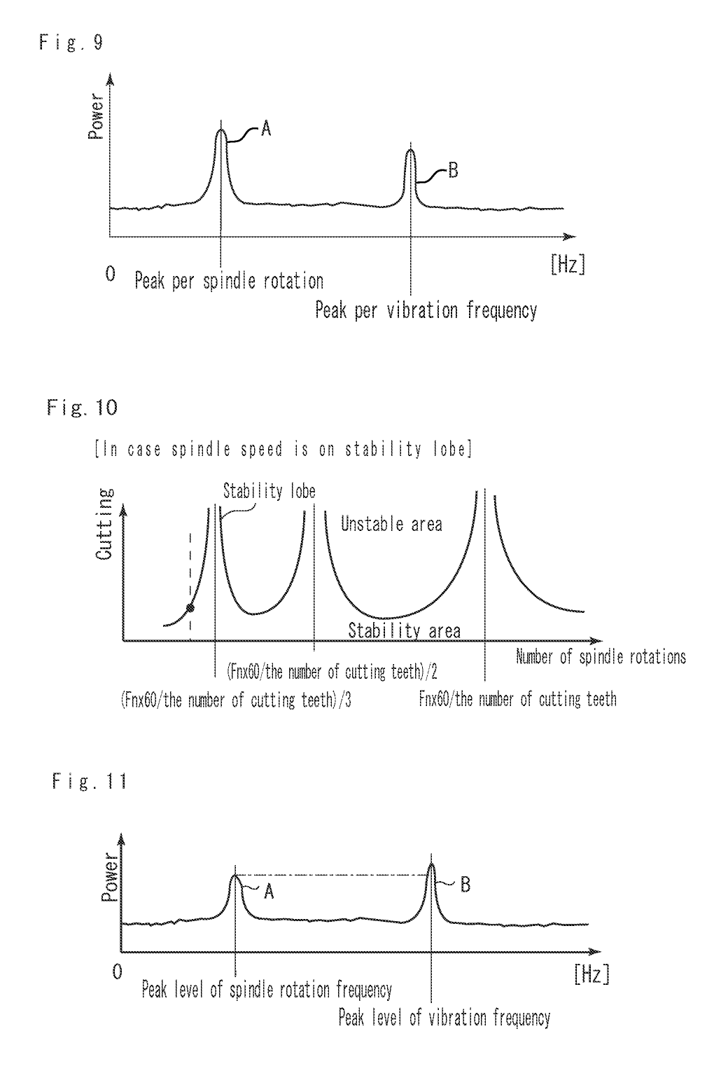

Comparison is performed in ascending order of frequency peak, and with any peak value matching the harmonic, this is deleted. As a result, harmonics (second-order harmonic component C and third-order harmonic component D) are deleted and only a fundamental frequency component remains, and this means that only a vibration frequency relating to a physical cause of the vibration is detected (refer to FIG. 9).

By this harmonic component deletion processing, signals that are not chatter, that is, spurious signals, etc., can be deleted, so that the reliability of signal analysis can be increased. This performs a role as a detection safety measure, and is effective particularly in a case where vibration is detected by the microphone 34.

Similarly, a next frequency peak (fundamental wave) of maximum power is searched for (Step S13), and when it is determined that no next peak exists (YES in Step S14), the process advances to Step S15 and it is determined whether the vibration is chatter vibration.

In the first embodiment, analysis is performed in a practical vibration range (for example, 20 Hz to 4000 Hz), and the vibration frequency includes the vibration frequency (including harmonics) of the number of rotations of the spindle 18, the vibration frequency (including harmonics) obtained by multiplication of the number of cutting teeth of the bar tool 22 to be used for the spindle, and a chatter vibration frequency caused by machining.

Therefore, the number of rotations of the spindle 18 and the number of cutting teeth of the bar tool 22, etc., are input in advance in the chatter suppressing arithmetic unit 38. Therefore, vibration not corresponding to the vibration frequency of the number of rotations of the spindle 18 and the vibration frequency obtained by multiplication of the number of cutting teeth of the bar tool 22 becomes a chatter vibration frequency or a predictive sign thereof. Therefore, by always performing this series of processing from the time of machining start, a predictive sign of chatter vibration can be automatically calculated from mechanical vibration.

In detail, comparison is performed to determine whether a peak value of the calculated frequency from which harmonic components were deleted is equal to the vibration frequency (the number of rotations/60) of the spindle 18 input in advance as a machining condition or the vibration frequency (the number of rotations×the number of cutting teeth/60) of the bar tool 22 (Step S16 and Step S17).

Here, when the peak value of the calculated frequency is equal to the information value input in advance (YES in Steps S16 and S17), it is determined as forced vibration caused by machining force fluctuation due to rotational machining of the spindle 18 or intermittent repetition of cutting by the cutting teeth of the bar tool 22 (Step S18), and the process returns to vibration monitoring (Step S19).

On the other hand, when a calculated frequency peak that does not meet this condition is detected (NO in Steps S16 and S17), it is determined as a frequency of regenerative chatter (Step S20), and the process advances to instruct a change in the number of mechanical rotations for adjusting the number of rotations of the spindle 18 (Step S21).

For example, when cutting machinability of the workpiece W is low or when the workpiece W is thin in thickness and the machining state easily changes according to the progress of machining, chatter easily occurs with the progress of machining.

Stages of such a predictive sign of chatter vibration are shown in FIG. 10 and FIG. 11. Specifically, when the stability lobe shifts due to deterioration with age, the number of rotations of the spindle 18 moves onto the lobe of the stability pocket. In this state, although the rotation of the spindle 18 during machining is stable, vibration amplitude of a specific frequency increases. This is a state where predictive vibration of chatter occurs. Further, if machining is continued in this state, chatter vibration continuously increases, and the predictive sign grows to harmful vibration.

Therefore, in the first embodiment, to suppress chatter vibration, the machining state is monitored in real time, and when predictive vibration of chatter occurs, by using vibration frequency thereof, frequency×60/the number of cutting teeth (or multiplication thereof) is calculated based on the stability pocket method. Accordingly, an updated number of rotations of the spindle 18 is calculated, and this automatically indicates a central number of rotations of the stability pocket method.

Next, the chatter suppressing arithmetic unit 38 displays the calculated updated number of rotations of the spindle 18 on the display unit 44, and automatically feedback-outputs it from the updated number output unit 46 to the machine tool control device 28 as a number-of-rotations change signal of the machine (for example, an override instruction to change the number of rotations of the spindle 18 from the outside). Therefore, the number of rotations of the machine tool 12 is immediately changed to the instructed number of rotations of the spindle 18, and cutting without harmful chatter is realized.

Thus, vibration of machining is monitored in real time from the time of start of rotation of the spindle 18, that is, from a timing at which machining is started in a state without chatter (=monitoring start instruction timing). Then, based on predictive vibration of chatter, the number of rotations of the spindle 18 is immediately changed to an optimum number of machining rotations that does not cause chatter according to the stability pocket method, and chatter is suppressed within the time period in which the predictive sign appears.

Accordingly, by adopting this method, even when machining is started at a number of rotations of the spindle 18 included in the stability area of the stability pocket method, even when the stability area shifts due to machining deterioration with age (for example, machining point change, thickness change of the workpiece W, etc.) and the number of rotations of the spindle 18 shifts into the stability lobe area of the stability pocket method, and even when the number of rotations of the spindle 18 further shifts into an unstable area of the stability pocket method, from these vibrations, calculation is immediately started and the number of rotations of the spindle 18 can be shifted to the central number of rotations in the stability area of the stability pocket method. Specifically, by immediately changing the number of rotations of the spindle 18 of the machine tool 12 based on the instruction, the machine tool automatically turns into a state where the number of rotations is changed to the central number of rotations in the stability area in which chatter does not occur.

In this case, in the first embodiment, vibration is detected from the start of rotation and analyzed by Fourier series expansion. In Fourier series expansion, the calculation is simple and quick processing is possible, so that immediacy is excellently improved, and before chatter actually occurs, chatter vibration can be predicted.

Therefore, regenerative chatter whose vibration grows from zero as the rotation starts can be predicted as quickly as possible. Accordingly, before an influence of the chatter actually occurs, the number of rotations of the spindle 18 can be adjusted, so that regenerative chatter can be reliably suppressed from occurring.

In addition, by setting vibration occurring when the spindle 18 idles as tolerance, a threshold is calculated. Therefore, when machining vibration is monitored in actual machining and vibration exceeding a threshold of idling tolerance is detected, it can be quickly detected as a predictive sign of chatter vibration.

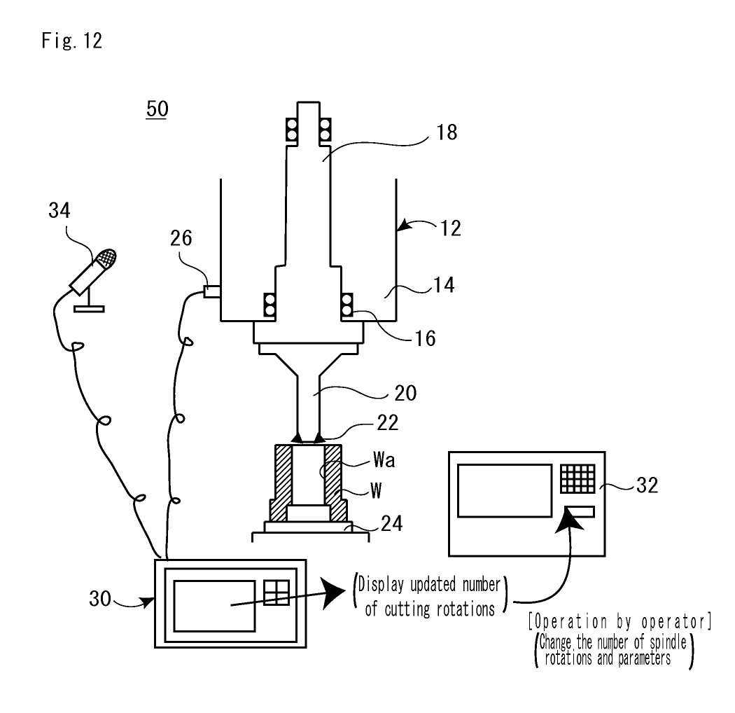

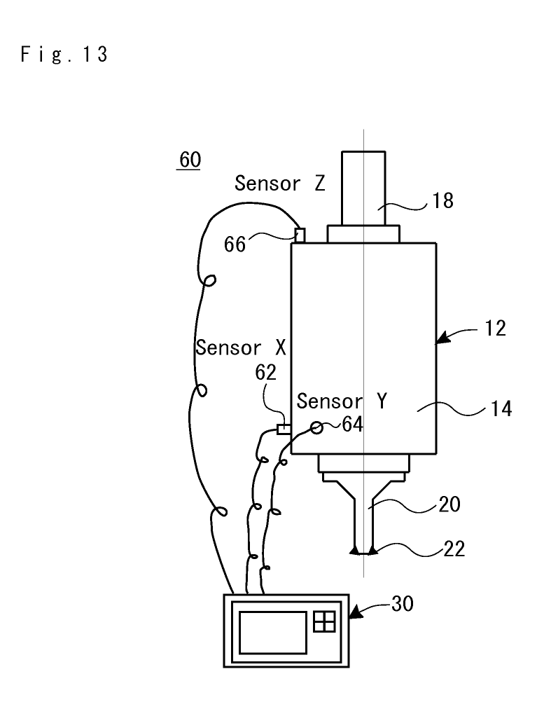

FIG. 12 is a schematic explanatory view of a chatter suppressing device 50 for an operating machine according to a second embodiment of the present invention.

Components identical to those in the chatter suppressing device 10 according to the first embodiment are designated by the same reference numerals, and detailed description thereof will be omitted. Similarly, detailed description of identical components will be omitted in a third embodiment described later.

In the chatter suppressing device 10 according to the first embodiment, the chatter suppressing arithmetic unit 38 displays an instruction to change the number of rotations of the spindle 18 on the display unit 44, and the updated number output unit 46 automatically outputs the updated number of spindle rotations to the machine tool control device 28 of the machine tool 12.

On the other hand, in the chatter suppressing device 50, an instruction to change the number of rotations of the spindle 18 is displayed on the display unit 44, and on the other hand, a change in the number of rotations of the spindle 18 of the machine tool 12 (for example, override value change for changing the number of spindle rotations) is performed by a manual operation on the control operation panel 32 by an operator. Therefore, the system that receives an instruction signal used for automatic updating and feeds back the instruction signal to a change in the number of rotations of the spindle 18 becomes unnecessary.

FIG. 13 is a schematic explanatory view of the chatter suppressing device 60 for an operating machine according to the third embodiment of the present invention.

For detecting vibration occurring when the boring bar 20 is started to rotate, the chatter suppressing device 60 includes acceleration sensors (vibration detection mechanisms) 62, 64, and 66 that detect vibrations in three directions of the X-axis direction, the Y-axis direction, and the Z-axis direction on the housing 14.

Mechanical vibration has directionality, and has unique properties, that is, for example, vibration in the Z-axis direction hardly occurs, etc., while vibration in the X-axis direction easily occurs. In a case where mechanical vibration is detected when it is very small like a predictive sign of chatter, vibration must be detected with high sensitivity regardless of the direction of the vibration.

Therefore, in the third embodiment, the acceleration sensors 62, 64, and 66 are attached in three directions, in the X-axis direction, the Y-axis direction, and the Z-axis direction orthogonal to each other. Therefore, the accuracy of vibration acquisition can be effectively improved, and a predictive sign of chatter vibration can be more reliably and quickly detected.

When the acceleration sensors 62, 64, and 66 are attached to the workpiece W side, the same effect is obtained. Even when microphones that detect mechanical vibration as transmission of acoustic waves are used without directly attaching the acceleration sensors 62, 64, and 66 to the housing 14, the same effect is obtained. In this case, by providing a plurality of microphones in the same manner as the acceleration sensors 62, 64, and 66, the accuracy of vibration acquisition can be increased.

With the chatter suppressing method and device for a work machine according to the present invention, vibration is detected from the start of rotation and analyzed by Fourier series expansion. In Fourier series expansion, the calculation is simple and quick processing is possible, so that immediacy is excellently improved, and before chatter actually occurs, chatter vibration can be predicted.

Therefore, regenerative chatter whose vibration grows from zero as the rotation starts can be predicted as quickly as possible. Accordingly, before an influence of the chatter actually occurs, the number of machine spindle rotations can be adjusted, so that regenerative chatter can be reliably suppressed from occurring.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A chatter suppressing method for a work machine for suppressing the occurrence of chatter when machining a workpiece via a working tool, comprising the steps of:
detecting vibration occurring when the working tool or the workpiece is started to rotate;
determining whether the vibration detected from the start of rotation has exceeded a threshold; and
analyzing the vibration by Fourier series expansion when it is determined that the vibration has exceeded the threshold and adjusting the number of rotations of a machine spindle based on an arithmetic expression of frequency×60/the number of cutting teeth or multiplication thereof.

2. The chatter suppressing method for a work machine according to claim 1, wherein the threshold is vibration occurring when the machine spindle idles.

3. The chatter suppressing method for a work machine according to claim 1, wherein a peak frequency is calculated in an integration interval that is an integral multiple of a period (1/frequency) by the Fourier series expansion.

4. The chatter suppressing method for a work machine according to claim 1, further comprising the steps of:
calculating a peak frequency in units of a first frequency in an integration interval that is an integer multiple of the period (1/frequency) by the Fourier series expansion, and
calculating a peak frequency in units of a second frequency obtained by segmentalizing the first frequency before and after the calculated peak frequency.

5. The chatter suppressing method for a work machine according claim 1, wherein in a state where harmonic components are deleted from frequency components calculated by the Fourier series expansion, the calculated frequency components and the threshold are compared with each other.

6. The chatter suppressing method for a work machine according to claim 1, further comprising a step of determining whether a frequency component calculated by the Fourier series expansion is vibration caused by regenerative chatter.

7. A chatter suppressing device for a work machine for suppressing the occurrence of chatter when machining a workpiece via a working tool, comprising:
a vibration detection mechanism that detects vibration occurring when the working tool or the workpiece is started to rotate;
a determination mechanism that determines whether the vibration detected from the start of rotation has exceeded a threshold;
an arithmetic mechanism that analyzes the vibration detected from the start of rotation by Fourier series expansion when it is determined that the vibration has exceeded the threshold, and adjusts the number of rotations of a machine spindle based on an arithmetic expression of frequency×60/the number of cutting teeth or multiplication thereof.

8. The chatter suppressing device for a work machine according to claim 7, wherein the threshold is vibration occurring when the machine spindle idles.

9. The chatter suppressing device for a work machine according to claim 7, wherein the arithmetic mechanism calculates a peak frequency in an integration interval that is an integer multiple of a period (1/frequency) by the Fourier series expansion.

10. The chatter suppressing device for a work machine according to claim 7, wherein the arithmetic mechanism after a peak frequency is calculated in units of a first frequency in the integration interval that is an integer multiple of the period (1/frequency) by the Fourier series expansion, before and after the calculated peak frequency, a peak frequency is calculated in units of a second frequency obtained by segmentalizing the first frequency.

11. The chatter suppressing device for a work machine according to claim 7, wherein the arithmetic mechanism deletes harmonic components from frequency components calculated by the Fourier series expansion.

12. The chatter suppressing device for a work machine according to claim 7, wherein the arithmetic mechanism determines whether a frequency component calculated by the Fourier series expansion is vibration caused by regenerative chatter.
